(19) United States
(12) Patent Application Publication
(10) Pub. No.: US 2007/0067337 A1
(43) Pub. Date: Mar. 22, 2007

(54) METHOD OF MANAGING RETRIEVAL OF DATA OBJECTS FROM A STORAGE DEVICE

(76) Inventors: John Mark Morris, San Diego, CA (US); Carson Schmidt, Poway, CA (US)

Correspondence Address: John D. Cowart;NCR Corporation, Intellectual Property Section, Law Department, 1700 South Patterson Blvd., Dayton, OH, 45479-0001, US

(21) Appl. No.: 11/470,283

(22) Filed: Sep. 6, 2006

Related U.S. Application Data
(60) Provisional application No. 60/719,475, filed on Sep. 22, 2005.

(51) Int. Cl. G06F 17/00

(52) U.S. Cl. 707/103 R

(57) ABSTRACT

A technique for use in managing retrieval of data objects from a storage device involves receiving over a communications bus a query to retrieve one or more data objects from the storage device. The query is used to generate one or more predicate conditionals such that data objects that do not satisfy at least one of the predicate conditionals do not satisfy the query. One or more data objects that satisfy the one or more predicate conditionals are then retrieved from the storage device and transmitted over the communications bus.

### CROSS-REFERENCE TO RELATED APPLICATION

This application claims priority from U.S. Provisional Application 60/719,475, filed on Sep. 20, 2005, by John Mark Morris and Carson Schmidt.

### BACKGROUND

Computer systems generally include one or more processors interfaced to a temporary data storage device such as a memory device and one or more persistent data storage devices such as disk drives. Data is usually transferred between the memory device and the disk drives over a communications bus or similar. Once data has been transferred from the disk drives to a memory device accessible by a processor, database software is then able to examine the data to determine if it satisfies the conditions of a query.

In data mining and decision support applications, it is often necessary to scan large amounts of data to include or exclude relational data in an answer set. This inevitably leads to the transfer of large amounts of data from the disk drives to the memory device over the communications bus. It is desirable to minimize the amount of data transferred so as to remove sources of contention or bottleneck and ultimately to reduce the time required to process a query.

Some queries (in whole or in part) are able to be applied to data closer to the point where data emerges from the disk drives. Query predicates can be “pushed” across the communications bus or other interconnect. A typical solution would be to push the file system and some processing capability near to the disk drives to accomplish the data qualification. However, such an architecture has implications on complexity, compatibility and performance that are often unacceptable.

### SUMMARY

Described below is a method of managing retrieval of data objects from a storage device. One technique described below involves receiving over a communications bus a query to retrieve one or more data objects from the storage device. The query is used to generate one or more predicate conditionals such that data objects that do not satisfy at least one of the predicate conditionals do not satisfy the query. One or more data objects that satisfy the one or more predicate conditionals are then retrieved from the storage device and transmitted over the communications bus.

In another technique a query to retrieve one or more data objects from the storage device is received. The query is used to generate one or more predicate conditionals such that data objects that do not satisfy at least one of the predicate conditionals do not satisfy the query. A request is transmitted to retrieve from the storage device one or more data objects that satisfy the one or more predicate conditionals. One or more data objects that satisfy the one or more predicate conditionals are then received and the query is applied to the one or more received data objects.

Another technique described below involves receiving one or more predicate conditionals to retrieve one or more data objects from the storage device. The predicate conditional(s) have been generated from a received query such that data objects that do not satisfy at least one of the predicate conditionals do not satisfy the query. One or more data objects satisfying the one or more predicate conditionals are then retrieved from the storage device.

In one form a selection of bytes in one of the data objects is assessed to determine whether it matches a byte sequence associated with one of the predicate conditionals. If there is a match, the technique concludes that the data object satisfies the predicate conditional if the selection of bytes matches the byte sequence.

In some systems the predicate conditional is associated with a range of byte positions and the bytes of the data object within the range of byte positions are assessed for a match with the byte sequence. The range of byte positions is specified in some systems by a starting offset and consecutive bytes of the data object following the starting offset are assessed for a match with the byte sequence. In other systems, the range of byte positions is specified by an ending offset and consecutive bytes of the data object preceding the ending offset are assessed for a match with the byte sequence. In yet other systems the range of byte positions is instead specified by both a starting offset and an ending offset and consecutive bytes of the data object between the starting offset and the ending offset are assessed for a match with the byte sequence.

In other systems the range of byte positions is specified by a repeating offset and bytes of the data object positioned at the repeating offset within the data object are assessed for a match with the byte sequence.

As an alternative to or as an addition to the selection of bytes matching a byte sequence, in some systems the selection of bytes is assessed with a comparison operator and/or an inequality operator.

It is envisaged that the system is configured to examine byte sequences in either Big Endian order or Little Endian order.

### BRIEF DESCRIPTION OF THE DRAWINGS

FIG. 1 is a block diagram of a computer system in which the techniques described below are implemented.

FIG. 2 is a flow chart of a technique for selecting data objects to retrieve from a storage device.

FIG. 3 is a diagram of a database table that stores data about customers of an organization.

FIG. 4 is a diagram of data objects representing the table of FIG. 3.

FIG. 5 is a block diagram of an exemplary large computer system in which the techniques described below are implemented.

### DETAILED DESCRIPTION

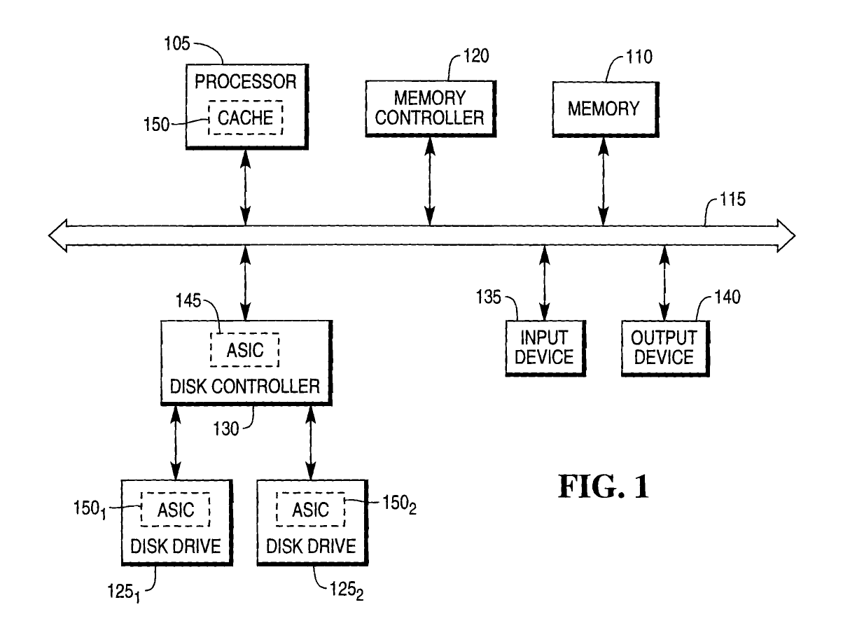

FIG. 1 shows a computer system 100 suitable for implementation of a method of managing retrieval of data objects. The system 100 includes one or more processors 105 that receive data and program instructions from a temporary data storage device, such as a memory device 110, over a communications bus 115. A memory controller 120 governs the flow of data into and out of the memory device 110. The system 100 also includes one or more persistent data storage devices, such as disk drives 125₁ and 125₂ that store chunks of data or data objects in a manner prescribed by one or more disk controllers 130. One or more input devices 135, such as a mouse and a keyboard, and output devices 140, such as a monitor and a printer, allow the computer system to interact with a human user and with other computers.

On instructions from the memory controller 120, data objects are retrieved via the disk controller(s) 130 from the disk drives 125. The retrieved data objects are stored in memory 110 for subsequent access by the processor 105. Repeated requests for data from the disk drives arising from user-generated or computer-generated queries can affect the performance of the computer system 100 due to the delay in transmitting or transferring data objects retrieved from the disk drives over the communications bus 115.

The system 100 in one form includes a data cache 150 that typically resides on processor(s) 105, one of the disk drives 125 and/or memory 110. The data cache 150 maintains a copy of certain data objects retrieved or written to the disk drives. The intention of the data cache is to speed up performance of the system 100 by reducing the number of data objects retrieved from the disk drives 125. If copies of these data objects are readily available to the processor 105 from the cache 150, then the need to retrieve those objects from the disk drives is reduced. The data cache 150 has potential to reduce the number of data objects needing to be transmitted over the communications bus 115. However, the data cache is typically of a fixed size and can only store a finite number of finite objects. Furthermore, on execution of a user query, data objects that match the query as well as data objects that do not match the query are typically transmitted over the communications bus before the query is applied to the data.

The techniques described below involve reducing the number of data blocks transmitted over the communications bus by eliminating transfer of data objects that would not satisfy a user query. The technique is best implemented in an application-specific integrated circuit (ASIC) that is configured to process a data stream operating in real time. The ASIC is designed into the data path of a computer system 100. In one form an ASIC 145 is associated with a disk controller 130 and in another form ASICs 150₁ and 150₂ are associated with disk drives 125₁ and 125₂ respectively.

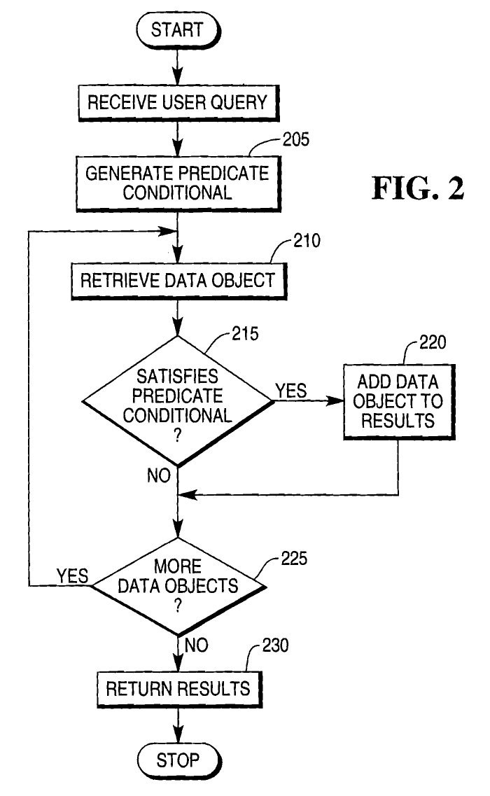

FIG. 2 shows an example of one technique of reducing data traffic over the communications bus. The system first receives a user query from a requesting device (step 200). The user query would typically be in a query language such as SQL. The system then generates one or more predicate conditionals from the user query (step 205). The predicate conditional would be specified as an equality match for a byte sequence that could represent byte data, character string data, integer data, floating point data or other data types. The predicate conditional could also include a comparison operator, for example greater than, less than or not equal operators.

A data object is then retrieved from the disk drives (step 210). The data chunk or data object is then analyzed to assess whether or not a selection of bytes in the data object matches the byte sequence associated with the predicate conditional. The predicate conditional in one form specifies an offset or a starting offset within the data object. A selection of bytes positioned within the data object running consecutively from the starting offset is then compared with the byte sequence associated with the user query. In another form the predicate conditional contains an ending offset and the selection of bytes in the data object is a consecutive string of bytes immediately preceding the ending offset.

In a further alternative the predicate conditional specifies both a starting and ending offset and the selection of bytes runs consecutively between the starting and ending offsets within the data object.

In a further form the predicate conditional is associated with a repeating offset. For example, where the repeating offset specifies two bytes, multiple byte sequences within the data object are compared with the byte sequence associated with the predicate conditional, each byte sequence offset from each other by two bytes. It will be appreciated that the repeating offset is any suitable integer value, for example 1, 2, 4, 7, 8, 16, 17 and so on.

In another form the predicate conditional is associated with both a repeating offset and a starting offset. One example is a predicate conditional specified as an equality match for a 10 byte sequence with a repeating offset of 1 and a starting offset of 7. The sequence of 10 bytes positioned within the data object running consecutively from the starting offset of 7 is compared with the 10 byte sequence associated with the user query/predicate conditional. The starting offset is then increased by the repeating offset so that the next 10 byte sequence examined runs from the new offset of 8, then 9, then 10 and so on.

The byte sequence specified by the above predicate conditional causes overlap in the sense that the predicate conditional tests more than one sequence of 10 bytes within the data object, and that some of the bytes in the data object are included in more than one of the sequences. This will generally occur when the length of the byte sequence associated with the predicate conditional exceeds the value of the repeating offset.

The predicate conditional is selected such that a data object that does not satisfy the predicate conditional does not satisfy the query from which the predicate conditional has been derived. Each retrieved data object is assessed to determine whether the selection of bytes in the data object matches the byte sequence associated with the predicate conditional (step 215). A data object that satisfies the predicate conditional is classified as “potentially matching” the query from which the predicate conditional has been derived. If the data object does not satisfy the predicate conditional, it is classified as “does not match”. If the data object has been classified as “potentially matches”, the data object is added to the collection of data objects that will be returned for evaluation of the user query (step 220).

Step 215 of determining whether a selection of bytes in the data object matches the byte sequence associated with the predicate conditional in one form also includes a data transformation. One example of a data transformation is where the byte sequence includes ASCII characters. A typical data transformation is the conversion of ASCII characters from lower case to upper case or the conversion of ASCII characters from upper case to lower case.

Step 215 in another form includes the application of a mathematical formula to the data. As described above, in one form the predicate conditional is specified as an equality match for a byte sequence that represents integer data. One example is a predicate query that tests for the integer value ‘100’ in byte sequences of length 8 within the data object with a repeating offset of 1.

This predicate is alternatively expressed using a mathematical formula such as the modulo operator to find multiples of an integer. The predicate expressed as a mathematical formula would test for modulo(x, 100)=0, where x is the number corresponding to interpreting each 8 byte sequence as an integer. This allows multiple matching sequences to be identified. An example of this is testing for the integer values ‘100’, ‘200’, ‘300’, ‘400’ and so on with just one predicate expressed as a mathematical formula including the modulo operator. A mathematical formula specified in this way is more efficient and in some cases has the ability to specify tests that would otherwise be impractical to specify with multiple predicates.

If there are further data objects to evaluate, these further data objects are examined (step 225). Once all data objects have been examined, there will be a collection of data objects that potentially match the user query. This collection of data objects is then transmitted to a convenient location, for example memory device 110, where the query can then be applied to the data objects (step 230).

While the process described with reference to FIG. 2 shows a single user query and a single predicate conditional, in practice a single query generates multiple conditionals and/or operators that can be applied in a single request.

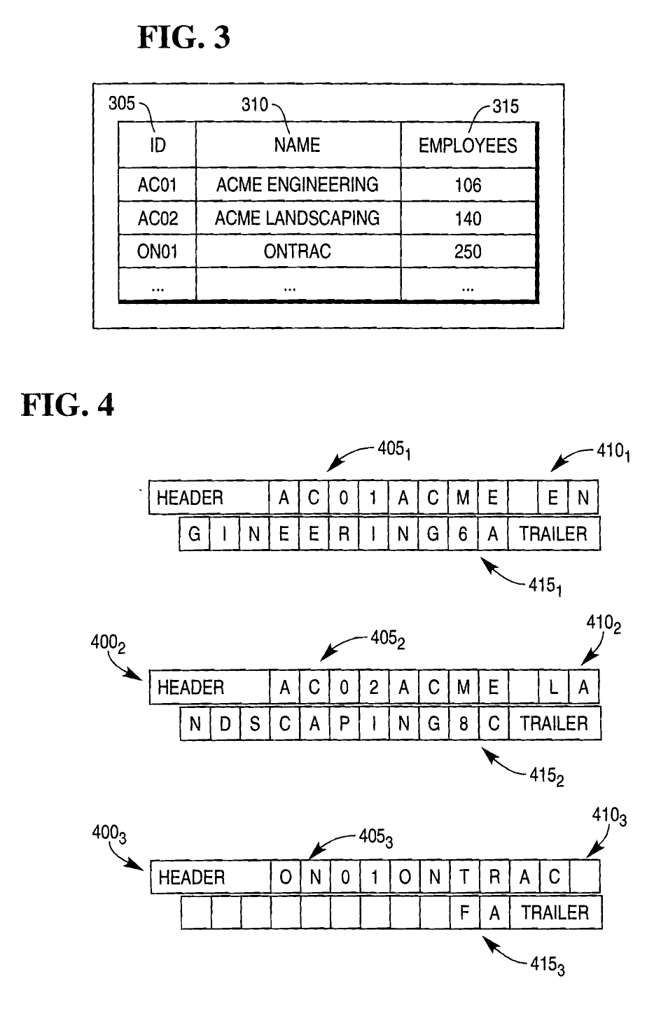

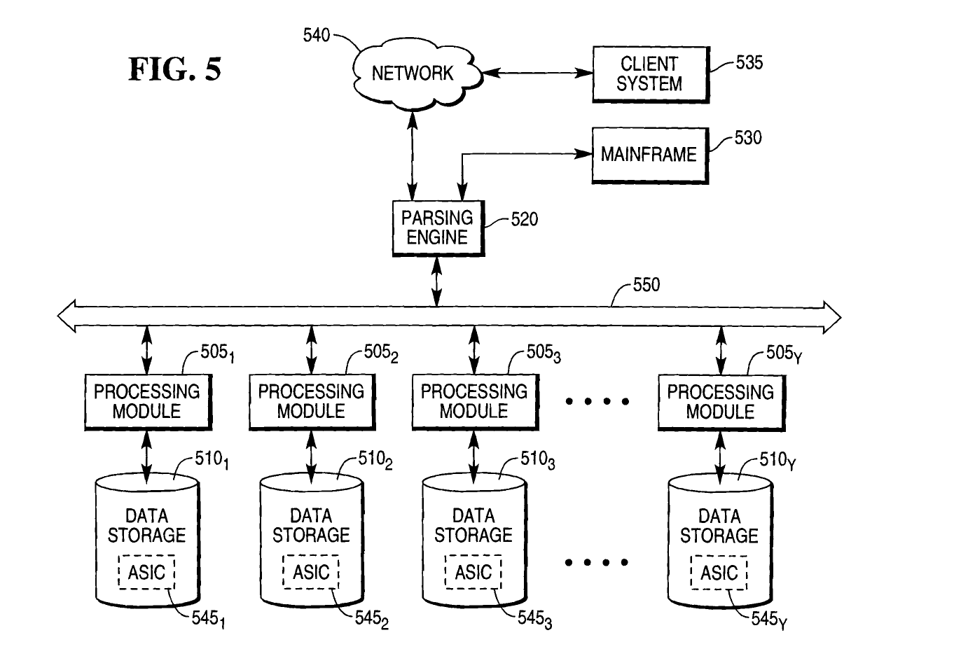

FIG. 3 shows a database table 300 that might appear in a traditional data warehousing system. Each column of the customer table 300 stores information about a customer of a business enterprise. For example, the customer table 300 shows information identifying the customer (ID, column 305), the name of the customer (NAME, column 310), and the number of employees employed by the customer (EMPLOYEES, column 315). In practice the customer table will include further data about the customer representing the value of that customer to the business. The table shown in FIG. 3 has been simplified for illustration purposes.

FIG. 4 shows a typical configuration for storing the data shown in customer table 300 on a disk drive. The data is stored as data blocks or data objects 400_{1 . . . 3} stored on a disk drive. In practice, each data block could be stored on a different disk drive. Each data object 400 is shown as including both a header and a trailer. Both the header and the trailer are of a fixed length and indicate the start and end of the data object respectively.

Each data block 400 includes ID from the customer table as a 4 byte data segment indicated at 405₁, 405₂ and 405₃. The data segments 405 follow the header in each of the data blocks. Each data block also includes NAME from the customer as a 16 byte data segment shown as 410_{1 . . . 3}. The name data segment 410 is followed by an employees data segment 415_{1 . . . 3}. The employee's data segment 415 is shown as a 2 byte hexadecimal number. The trailer for each data block immediately follows the employees data segment 415.

The data objects in one form are stored as a unit. A database relation or table (not shown) indexes a plurality of data blocks, each of which may further comprise a plurality of data objects. Predicates are applied to data blocks and not necessarily individual data objects within the data block.

The technique results in an overall reduction in the data retrieved despite the fact that in some cases predicates applied to data blocks may result in data blocks being selected that contain data objects that do not satisfy the predicate. Data blocks may also be selected in which none of the data objects satisfy the predicate, but the combination of two or more data objects within the data block when combined match the byte sequence associated with the predicate.

A typical user query for the customer table is as follows:

SELECT name FROM customer
WHERE name = ‘ACME Landscaping’

Ordinarily, the execution of this query would result in each of the customer data objects in the customer table 300 being retrieved from the disk drives and transferred to memory 110. The query would then be applied to these customer data objects and every customer data object except those containing ‘Acme Landscaping’ as customer would then be discarded.

The above query is instead used as a base to generate a predicate conditional that can be applied to data on the disk drives. A typical predicate conditional generated from the above user query would be:

Is there a 4 byte sequence in the data object that
matches ‘acme’?

This predicate conditional would retrieve data objects 400₁ and 400₂ from the disk drives but would not retrieve farther data objects from the disk drives unless those data objects included within the data object the string ‘acme’. Subsequent application of the query on the resulting data blocks would eliminate ‘Acme Engineering’ resulting in ‘Acme Landscaping’ as the result of the query. The effect of this technique is that only data objects 400₁ and 400₂ would be transmitted over the communications bus rather than multiple data blocks.

As described above, the predicate conditional in one form specifies a byte sequence and an offset. A typical predicate conditional would be as follows:

Is there a data block having a byte sequence ‘land’ at a
starting offset of 10 bytes from the end of the header
in a data block?

Another example of a predicate conditional is:

Is there a byte sequence ‘ing’ within a data block at an
ending offset of 5 bytes from the trailer?

A further predicate conditional is:

Is there a byte sequence ‘capi’ at an offset of 5 bytes
within a data block at a repeating offset of 2 bytes?

The above predicate conditional would execute as follows:

Is there a byte sequence ‘capi’ at a starting offset of
5 bytes?
Is there a byte sequence ‘capi’ at a starting offset of
7 bytes?
Is there a byte sequence “capi” at a starting offset of
9 bytes?
... and so on ...

The predicate conditionals above would each be satisfied by data object 400₂.

The technique is most effective where the data objects being analyzed are neither compressed nor encrypted such that the patterns sought in the data are obfuscated. Where the technique is applied to data objects that have been compressed, it is envisaged that the data object is decompressed before testing whether the object satisfies the predicate conditional. Similarly, where a data object is encrypted, it is expected that the data object will be decrypted before applying the predicate conditionals.

FIG. 4 shows an example of one type of computer system in which the above techniques of managing the retrieval of data objects are implemented. The computer system is a data warehousing system 500, such as a TERADATA data warehousing system sold by NCR Corporation, in which vast amounts of data are stored on many disk-storage facilities that are managed by many processing units. In this example, the data warehouse 500 includes a relational database management system (RDMS) built upon a massively parallel processing (MPP) platform. Other types of database systems, such as object-relational database management systems (ORDMS) or those built on symmetric multi-processing (SMP) platforms, are also suited for use here.

As shown here, the data warehouse 500 includes one or more processing modules 505_{1 . . . y} that manage the storage and retrieval of data in data storage facilities 510_{1 . . . y}. Each of the processing modules 505_{1 . . . y} manages a portion of a database that is stored in a corresponding one of the data storage facilities 510_{1 . . . y}. Each of the data storage facilities 510_{1 . . . y} includes one or more disk drives.

A parsing engine 520 organizes the storage of data and the distribution of data objects stored in the disk drives among the processing modules 505_{1 . . . y}. The parsing engine 520 also coordinates the retrieval of data from the data storage facilities 510_{1 . . . y} in response to queries received from a user at a mainframe 530 or a client computer 535 through a wired or wireless network 540. An application-specific integrated circuit (ASIC) configured to perform the techniques described above is indicated as ASIC 545_{1 . . . y}. The ASIC 545 could be associated with disk drives forming part of the data storage facilities 510 or associated with one or more disk controllers (not shown). The goal of the ASIC 545 is to reduce the quantity of data objects transmitted from data storage 510 to the processing modules 505.

The text above describes one or more specific embodiments of a broader invention. The invention also is carried out in a variety of alternative embodiments and thus is not limited to those described here. Those other embodiments are also within the scope of the following claims.

We claim:

1. A method of managing retrieval of data objects from a storage device, the method comprising:
receiving over a communications bus a query to retrieve one or more data objects from the storage device;
generating from the query one or more predicate conditionals, such that data objects that do not satisfy at least one of the predicate conditionals do not satisfy the query;
retrieving from the storage device one or more data objects that satisfy the one or more predicate conditionals; and
transmitting the one or more data objects satisfying the one or more predicate conditionals over the communications bus.

2. The method of claim 1 further comprising:
assessing whether a selection of bytes in one of the data objects matches a byte sequence associated with one of the predicate conditionals; and
concluding that the data object(s) satisfies the predicate conditional if the selection of bytes matches the byte sequence.

3. The method of claim 2 where the predicate conditional is associated with a range of byte positions, and where the bytes of the data object within the range of byte positions are assessed for a match with the byte sequence.

4. The method of claim 3 wherein the range of byte positions is specified by a starting offset.

5. The method of claim 4 where consecutive bytes of the data object following the starting offset are assessed for a match with the byte sequence.

6. The method of claim 5 where the range of byte positions is further specified by an ending offset, and where consecutive bytes of the data object following the starting offset and preceding the ending offset are assessed for a match with the byte sequence.

7. The method of claim 3 where the range of byte positions is specified by an ending offset.

8. The method of claim 7 where consecutive bytes of the data object preceding the ending offset are assessed for a match with the byte sequence.

9. The method of claim 8 where the range of byte positions is further specified by a starting offset, and where further consecutive bytes of the data object following the starting offset and preceding the ending offset are assessed for a match with the byte sequence.

10. The method of claim 3 where the range of byte positions is specified by a repeating offset.

11. The method of claim 10 where bytes of the data object positioned at the repeating offset within the data object are assessed for a match with the byte sequence.

12. The method of claim 1 further comprising:
applying a data transformation to a selection of bytes in one of the data objects;
assessing whether the transformed selection of bytes matches a byte sequence associated with one of the predicate conditionals; and
concluding that the data object(s) satisfies the predicate conditional if the selection of bytes matches the byte sequence.

13. The method of claim 1 further comprising:
assessing whether a selection of bytes in one of the data objects satisfies a comparison operator associated with one of the predicate conditionals; and
concluding that the data object satisfies the predicate conditional if the selection of bytes satisfies the comparison operator.

14. The method of claim 1 further comprising:
assessing whether a selection of bytes in one of the data objects satisfies an inequality operator associated with one of the predicate conditionals; and
concluding that the data object satisfies the predicate conditional if the selection of bytes satisfies the comparison operator.

15. The method of claim 2 where the byte sequence of the predicate conditional is examined in Big Endian order.

16. The method of claim 2 where the byte sequence of the predicate conditional is examined in Little Endian order.

17. A method of managing retrieval of data objects from a storage device, the method comprising:
receiving a query to retrieve one or more data objects from the storage device;
generating from the query one or more predicate conditionals such that data objects that do not satisfy at least one of the predicate conditionals do not satisfy the query;
transmitting a request to retrieve from the storage device one or more data objects that satisfy the one or more predicate conditionals;
receiving the one or more data objects that satisfy the one or more predicate conditionals; and
applying the query to the one or more received data objects.

18. The method of claim 17 further comprising:
assessing whether a selection of bytes in one of the data objects matches a byte sequence associated with one of the predicate conditionals; and
concluding that the data object(s) satisfies the predicate conditional if the selection of bytes matches the byte sequence.

19. The method of claim 18 where the predicate conditional is associated with a range of byte positions, and where the bytes of the data object within the range of byte positions are assessed for a match with the byte sequence.

20. The method of claim 19 wherein the range of byte positions is specified by a starting offset.

21. The method of claim 20 where consecutive bytes of the data object following the starting offset are assessed for a match with the byte sequence.

22. The method of claim 21 where the range of byte positions is further specified by an ending offset, and where consecutive bytes of the data object following the starting offset and preceding the ending offset are assessed for a match with the byte sequence.

23. The method of claim 19 where the range of byte positions is specified by an ending offset.

24. The method of claim 23 where consecutive bytes of the data object preceding the ending offset are assessed for a match with the byte sequence.

25. The method of claim 24 where the range of byte positions is further specified by a starting offset, and where further consecutive bytes of the data object following the starting offset and preceding the ending offset are assessed for a match with the byte sequence.

26. The method of claim 19 where the range of byte positions is specified by a repeating offset.

27. The method of claim 26 where bytes of the data object positioned at the repeating offset within the data object are assessed for a match with the byte sequence.

28. The method of claim 17 further comprising:
applying a data transformation to a selection of bytes in one of the data objects;
assessing whether the transformed selection of bytes matches a byte sequence associated with one of the predicate conditionals; and
concluding that the data object(s) satisfies the predicate conditional if the selection of bytes matches the byte sequence.

29. The method of claim 17 further comprising:
assessing whether a selection of bytes in one of the data objects satisfies a comparison operator associated with one of the predicate conditionals; and
concluding that the data object satisfies the predicate conditional if the selection of bytes satisfies the comparison operator.

30. The method of claim 17 further comprising:
assessing whether a selection of bytes in one of the data objects satisfies an inequality operator associated with one of the predicate conditionals; and
concluding that the data object satisfies the predicate conditional if the selection of bytes satisfies the comparison operator.

31. The method of claim 18 where the byte sequence of the predicate conditional is examined in Big Endian order.

32. The method of claim 18 where the byte sequence of the predicate conditional is examined in Little Endian order.

33. A method of managing retrieval of data objects from a storage device, the method comprising:
receiving one or more predicate conditionals to retrieve one or more data objects from the storage device, the predicate conditional(s) generated from a received query such that data objects that do not satisfy at least one of the predicate conditionals do not satisfy the query; and
retrieving from the storage device one or more data objects that satisfy the one or more predicate conditionals.

34. The method of claim 33 further comprising:
assessing whether a selection of bytes in one of the data objects matches a byte sequence associated with one of the predicate conditionals; and
concluding that the data object(s) satisfies the predicate conditional if the selection of bytes matches the byte sequence.

35. The method of claim 34 where the predicate conditional is associated with a range of byte positions, and where the bytes of the data object within the range of byte positions are assessed for a match with the byte sequence.

36. The method of claim 35 wherein the range of byte positions is specified by a starting offset.

37. The method of claim 36 where consecutive bytes of the data object following the starting offset are assessed for a match with the byte sequence.

38. The method of claim 37 where the range of byte positions is further specified by an ending offset, and where consecutive bytes of the data object following the starting offset and preceding the ending offset are assessed for a match with the byte sequence.

39. The method of claim 35 where the range of byte positions is specified by an ending offset.

40. The method of claim 39 where consecutive bytes of the data object preceding the ending offset are assessed for a match with the byte sequence.

41. The method of claim 40 where the range of byte positions is further specified by a starting offset, and where further consecutive bytes of the data object following the starting offset and preceding the ending offset are assessed for a match with the byte sequence.

42. The method of claim 35 where the range of byte positions is specified by a repeating offset.

43. The method of claim 42 where bytes of the data object positioned at the repeating offset within the data object are assessed for a match with the byte sequence.

44. The method of claim 33 further comprising:
applying a data transformation to a selection of bytes in one of the data objects;
assessing whether the transformed selection of bytes matches a byte sequence associated with one of the predicate conditionals; and
concluding that the data object(s) satisfies the predicate conditional if the selection of bytes matches the byte sequence.

45. The method of claim 33 further comprising:
assessing whether a selection of bytes in one of the data objects satisfies a comparison operator associated with one of the predicate conditionals; and
concluding that the data object satisfies the predicate conditional if the selection of bytes satisfies the comparison operator.

46. The method of claim 33 further comprising:
assessing whether a selection of bytes in one of the data objects satisfies an inequality operator associated with one of the predicate conditionals; and
concluding that the data object satisfies the predicate conditional if the selection of bytes satisfies the comparison operator.

47. The method of claim 34 where the byte sequence of the predicate conditional is examined in Big Endian order.

48. The method of claim 34 where the byte sequence of the predicate conditional is examined in Little Endian order.

49. A system for managing retrieval of data objects from a storage device, where the system is configured to:
receive over a communications bus a query to retrieve one or more data objects from the storage device;
generate from the query one or more predicate conditionals, such that data objects that do not satisfy at least one of the predicate conditionals do not satisfy the query;
retrieve from the storage device one or more data objects that satisfy the one or more predicate conditionals; and
transmit the one or more data objects satisfying the one or more predicate conditionals over the communications bus.

50. A system for managing retrieval of data objects from a storage device, where the system is configured to:
receive a query to retrieve one or more data objects from the storage device;
generate from the query one or more predicate conditionals such that data objects that do not satisfy at least one of the predicate conditionals do not satisfy the query;
transmit a request to retrieve from the storage device one or more data objects that satisfy the one or more predicate conditionals;
receive the one or more data objects that satisfy the one or more predicate conditionals; and
apply the query to the one or more received data objects.

51. A system for managing retrieval of data objects from a storage device, where the system is configured to:
receive one or more predicate conditionals to retrieve one or more data objects from the storage device, the predicate conditional(s) generated from a received query such that data objects that do not satisfy at least one of the predicate conditionals do not satisfy the query; and
retrieve from the storage device one or more data objects that satisfy the one or more predicate conditionals.

52. A computer program stored on tangible storage medium comprising executable instructions for performing a method comprising:
receiving over a communications bus a query to retrieve one or more data objects from the storage device;
generating from the query one or more predicate conditionals, such that data objects that do not satisfy at least one of the predicate conditionals do not satisfy the query;
retrieving from the storage device one or more data objects that satisfy the one or more predicate conditionals; and
transmitting the one or more data objects satisfying the one or more predicate conditionals over the communications bus.

53. A computer program stored on tangible storage medium comprising executable instructions for performing a method comprising:
receiving a query to retrieve one or more data objects from the storage device;
generating from the query one or more predicate conditionals such that data objects that do not satisfy at least one of the predicate conditionals do not satisfy the query;
transmitting a request to retrieve from the storage device one or more data objects that satisfy the one or more predicate conditionals;
receiving the one or more data objects that satisfy the one or more predicate conditionals; and
applying the query to the one or more received data objects.

54. A computer program stored on tangible storage medium comprising executable instructions for performing a method comprising:
receiving one or more predicate conditionals to retrieve one or more data objects from the storage device, the predicate conditional(s) generated from a received query such that data objects that do not satisfy at least one of the predicate conditionals do not satisfy the query; and
retrieving from the storage device one or more data objects that satisfy the one or more predicate conditionals.
